(19) United States
(12) Patent Application Publication
(10) Pub. No.: US 2008/0108322 A1
(43) Pub. Date: May 8, 2008

(54) DEVICE AND / OR USER AUTHENTICATION FOR NETWORK ACCESS

(75) Inventor: Steven D. Upp, Bartlett, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/556,408

(22) Filed: Nov. 3, 2006

(51) Int. Cl. H04M 1/665

(52) U.S. Cl. 455/411

(57) ABSTRACT

Various embodiments are described for authenticating a wireless device (101) and/or an associated user subscription. By using a single authentication exchange with the wireless device to obtain a device credential, a connectivity service network (CSN) (231) authenticates and validates the device credential to establish a device identity. For device-identity-based subscription, the device identity may be used to validate a subscription. For user subscription authentication, a second authentication exchange is performed using the encrypted connection established by the first authentication exchange (a.k.a, the outer exchange). By utilizing only one outer authentication exchange, embodiments are made possible that exhibit reduced messaging and lower complexity when compared to known techniques.

### FIELD OF THE INVENTION

The present invention relates generally to communication systems and, in particular, to authenticating a wireless device by a connectivity service network (CSN) prior to granting access to an access service network (ASN).

### BACKGROUND OF THE INVENTION

WiMAX (Worldwide Interoperability for Microwave Access) Network Access Providers (NAPs) (e.g., wholesalers) and Network Service Providers (NSPs) (e.g., carriers) are interested in validating the certification state of a wireless device against a conformance standard prior to allowing the device onto their networks. The NAPs and NSPs are also obviously interested in authenticating the end user of the device to establish the validity of the user's subscription for service from the home service provider. WiMAX Devices will be manufactured with X.509 digital certificates from a trusted WIMAX device Certificate Authority so that the identity of these device can be strongly authenticated by both NAPs and NSPs. In general, Access Providers are interested in validating the conformance of devices to the standards prior to admitting the devices onto their networks. In addition, the identity of the user could also be authenticated with another credential such as a username-password combination, biometric data, a SmartCard or a removable SIM card.

IEEE 802.16-2005 defined a method intended to support two Extensible Authentication Protocol (EAP) methods in sequence. The method is called EAP after EAP, but it has not been included in the WiMAX Profile due to its complexity and interaction with the IEEE 802.16 air interface. EAP after EAP is complex in that one EAP method is completed successfully, establishing EAP keying material with a first Authentication Server, and then a second EAP method is initiated in which the keying material from the first session is used to authenticate the EAP messages for the second EAP method with a second Authentication Server. The establishment of these EAP sessions requires a substantial number of over-the-air messages.

Thus, it would be desirable to have a method and apparatus for authenticating a wireless device and the user of the device that was able to reduce some of the messaging and delays characteristic of today's techniques.

### BRIEF DESCRIPTION OF THE DRAWINGS

FIG. 1 is a block diagram depiction of a wireless communication system in accordance with multiple embodiments of the present invention.

FIG. 2 is a block diagram depiction of a wireless communication system in accordance with multiple embodiments of the present invention.

FIG. 3 is a signaling flow diagram that depicts an authentication exchange by which authentication and validation of a wireless device and/or a subscription (for device-identity-based subscriptions) may occur, in accordance with multiple embodiments of the present invention.

FIG. 4 is a signaling flow diagram that depicts two authentication exchanges by which authentication and validation of a wireless device and a user subscription may occur, in accordance with multiple embodiments of the present invention.

FIG. 5 is a detailed signaling flow diagram that depicts one example of the sort of signaling by which authentication and validation of a wireless device may be attempted, in accordance with a specific embodiment of the present invention.

FIG. 6 is a detailed signaling flow diagram that depicts one example of the sort of signaling by which authentication and validation of a wireless device and a user subscription may be attempted, in accordance with a specific embodiment of the present invention.

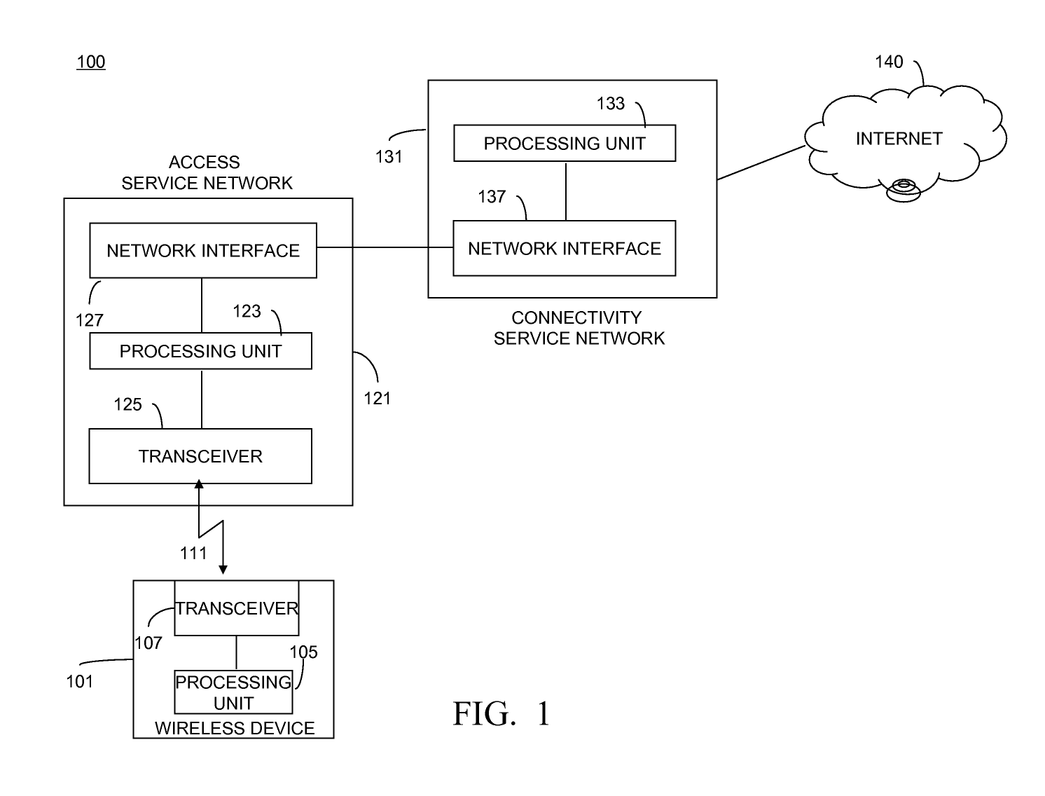

Specific embodiments of the present invention are disclosed below with reference to FIGS. 1-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams above are described and shown with reference to specific signaling exchanged in a specific order, some of the signaling may be omitted or some of the signaling may be combined, sub-divided, or reordered without departing from the scope of the claims. Thus, unless specifically indicated, the order and grouping of the signaling depicted is not a limitation of other embodiments that may lie within the scope of the claims

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described for authenticating a wireless device and/or an associated user subscription. By using a single authentication exchange with the wireless device to obtain a device credential, a connectivity service network (CSN) authenticates and validates the device credential to establish a device identity. For device-identity-based subscription, the device identity may be used to validate a subscription. For user subscription authentication, a second authentication exchange is performed using the encrypted connection established by the first authentication exchange (a.k.a, the outer exchange). By utilizing only one outer authentication exchange, embodiments are made possible that exhibit reduced messaging and lower complexity when compared to known techniques.

The disclosed embodiments can be more fully understood with reference to FIGS. 1-6. FIG. 1 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. In particular, access service network (ASN) 121 is shown communicating with wireless device 101 via wireless interface 111, this interface being in accordance with the particular access technology utilized by ASN 121, such as an IEEE 802.16-based wireless interface. In addition, CSN 131 is shown having network connectivity to ASN 121 and the Internet 140. Those skilled in the art will recognize that FIG. 1 does not depict all of the physical fixed network components that may be necessary for system 100 to operate but only those system components and logical entities particularly relevant to the description of embodiments herein.

For example, FIG. 1 depicts ASN 121 and connectivity service network (CSN) 131 as respectively comprising processing units 123 and 133 and network interfaces 127 and 137. In addition, FIG. 1 depicts ASN 121 as comprising transceiver 125. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, ASN 121 and CSN 131 represent known devices that have been adapted, in accordance with the description herein, to implement multiple embodiments of the present invention. Furthermore, those skilled in the art will recognize that aspects of the present invention may be implemented in and across various physical components and none are necessarily limited to single platform implementations. For example, processing unit 123, transceiver 125, and network interface 127 may be implemented in or across one or more network components, such as one or more base stations (BSs) and/or ASN gateways. Similarly, processing unit 133 and network interface 137 may be implemented in or across one or more network components, such as one or more routers, authentication proxies/servers, databases, and/or interworking gateway devices.

Wireless device 101 and ASN 121 is shown communicating via a technology-dependent, wireless interface. Wireless devices, subscriber stations (SSs) or user equipment (UEs), may be thought of as mobile stations (MSs); however, wireless devices are not necessarily mobile nor able to move. In addition, wireless device platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, wireless device 101 comprises processing unit (105) and transceiver (107). Depending on the embodiment, wireless device 101 may additionally comprise a keypad (not shown), a speaker (not shown), a microphone (not shown), and a display (not shown). Processing units, transceivers, keypads, speakers, microphones, and displays as used in wireless device are all well-known in the art. Thus, given a high-level description, an algorithm, a logic flow, a messaging/signaling flow, and/or a protocol specification, those skilled in the art are aware of the many design and development techniques available to implement a processing unit that performs the given logic. Therefore, wireless device 101 represents a known device that has been adapted, in accordance with the description herein, to implement multiple embodiments of the present invention.

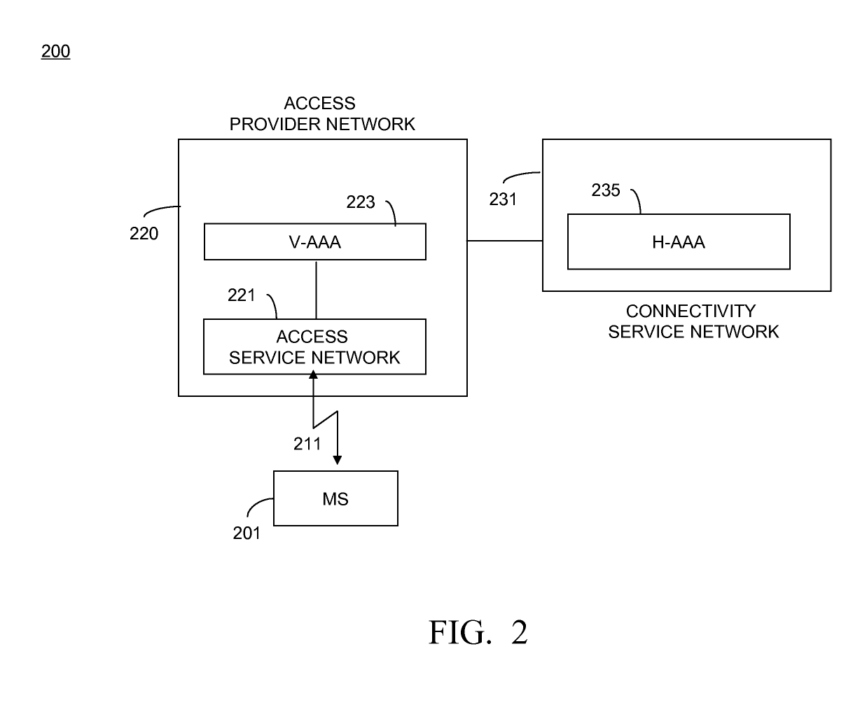

FIG. 2 is block diagram depiction of a wireless communication system 200 in accordance with multiple embodiments of the present invention. Communication system 200 is also depicted in a very generalized manner. Access provider network 220 is shown comprising Visited—Authentication, Authorization and Accounting Proxy Server (V-AAA) 223 and ASN 221, which has a wireless interface 211 with MS 201. CSN 231 is shown comprising Home—Authentication, Authorization and Accounting Server (H-AAA) 235. Again, those skilled in the art will recognize that FIG. 2 does not depict all of the physical fixed network components that may be necessary for system 200 to operate but only those system components and logical entities particularly relevant to the description of embodiments herein.

For example, an ASN in conformance with WiMAX Forum specifications would require networking elements enabling it to provide WiMAX Layer-2 (L2) connectivity with a WiMAX MS, to support the transfer of EAP contained within AAA messages to the WiMAX subscriber's Home Network Service Provider (H-NSP) for authentication, authorization and session accounting for subscriber sessions, to provide policy and admission control based on device authentication, to support network discovery and selection of the WiMAX subscriber's preferred NSP, to support relay functionality for establishing Layer-3 (L3) connectivity with a WiMAX MS (i.e., IP address allocation), to provide radio resource management, to support ASN-CSN tunneling, to support ASN anchor mobility, to support CSN anchor mobility, and to provide paging and location management. In addition, an ASN may be shared by more than one CSN. A CSN in conformance with WiMAX Forum specifications would require networking elements enabling it to provide IP connectivity services to the WiMAX subscribers. Thus, such a CSN may need to provide MS IP address and endpoint parameter allocation for user sessions, to provide access to the Internet, to provide policy and admission control based on device and or user subscription profiles, to support ASN-CSN tunneling, to support WiMAX subscriber billing and inter-operator settlement, to support inter-CSN tunneling for roaming, and to support inter-ASN mobility. A WiMAX CSN may also need to provide WiMAX services such as location based services, connectivity for peer-to-peer services, provisioning, authorization and/or connectivity to IP multimedia services and facilities to support lawful intercept services such as those compliant with Communications Assistance Law Enforcement Act (CALEA) procedures.

Operation of embodiments in accordance with the present invention occurs substantially as follows, first with reference to FIG. 1. Having received a request for network access from wireless device 101, ASN 121 requests CSN 131 to authenticate wireless device 101. Depending on the embodiment, a portion of processing unit 123 and network interface 127 may comprise a V-AAA (or some part thereof), a network authenticator, and/or a proxy authenticator. Similarly, depending on the embodiment, a portion of processing unit 133 and network interface 137 may comprise an H-AAA (or some part thereof) and/or a network authenticator. CSN processing unit 133 and wireless device processing unit 105 perform an authentication exchange via network interface 137, ASN 121, and transceiver 107.

In this authentication exchange, CSN 131 requests a device credential from wireless device 101. CSN processing unit 133 then attempts to establish an identity of the wireless device. If a device credential is obtained from the wireless device, establishing the device identity involves authenticating and validating the device credential. Typically, a digital certificate, such as an X.509-compliant digit certificate is used. In WiMAX embodiments, a digital certificate obtained from a WiMAX certificate authority and installed by a wireless device manufacturer may be used. In some embodiments, device processing unit 105 requests a server credential from CSN processing unit 133 during the authentication exchange in order to validate the server.

As a result of the CSN's attempt to establish an identity of the wireless device, CSN processing unit 133 indicates to ASN processing unit 123, via network interfaces 127 and 137, authentication-related information for device 101. What information is indicated is highly dependent upon the embodiment. For example, any of the following information may be indicated: the established identity of the wireless device (MAC address, e.g.), whether the wireless device was successfully authenticated and validated, whether a Certificate Revocation List (CRL) check was performed, a hardware version of the wireless device, a manufacturer of the wireless device, information obtained from the device credential, a network interoperability certification compliance grade (such as a WiMAX minimum certification grade), the identity of the root Certificate Authority, the entire contents of the subject identity or other WiMAX specific fields from within the device certificate that contain relevant identifying information, a session authentication key (such as a Master Session Key), an allowed QoS (quality of service), an allowed mobility class, mobility parameters, and/or accounting parameters.

Using the received authentication-related information for device 101, ASN processing unit 123 determines whether to grant access to device 101. What access policies may be used to determine network access will, of course, vary from one embodiment to the next, and may be dynamic or even varying in real-time with network conditions. ASN processing unit 123 then indicates to device processing unit 105 whether device 101 has been granted access or not.

In addition to device authentication, as described above, CSN 131 may in some embodiments also validate service subscription. For subscriptions that are device-identity-based, CSN processing unit 133 may utilize a device identity obtained from the device credential to validate the device-identity-based subscription. For subscriptions that involve user authentication, CSN processing unit 133 may use an authentication exchange method that enables an encrypted connection, such as an encrypted tunnel, to be established between CSN processing unit 133 and device processing unit 105.

Processing units 133 and 105 then use the encrypted connection to perform a second authentication exchange. In this second exchange, CSN processing unit 133 requests a user subscription credential from device 101. Processing unit 105 provides a user subscription credential, which may take the form of a user name and password combination, biometric information, a preshared key, and/or subscriber identity information (such as from a SmartCard or a SIM card, e.g.), depending on the embodiment. CSN processing unit 133 then attempts to validate the user subscription using the user subscription credential received. CSN processing unit 133 then proceeds to indicate to ASN processing unit 123 the authentication-related information for device 101.

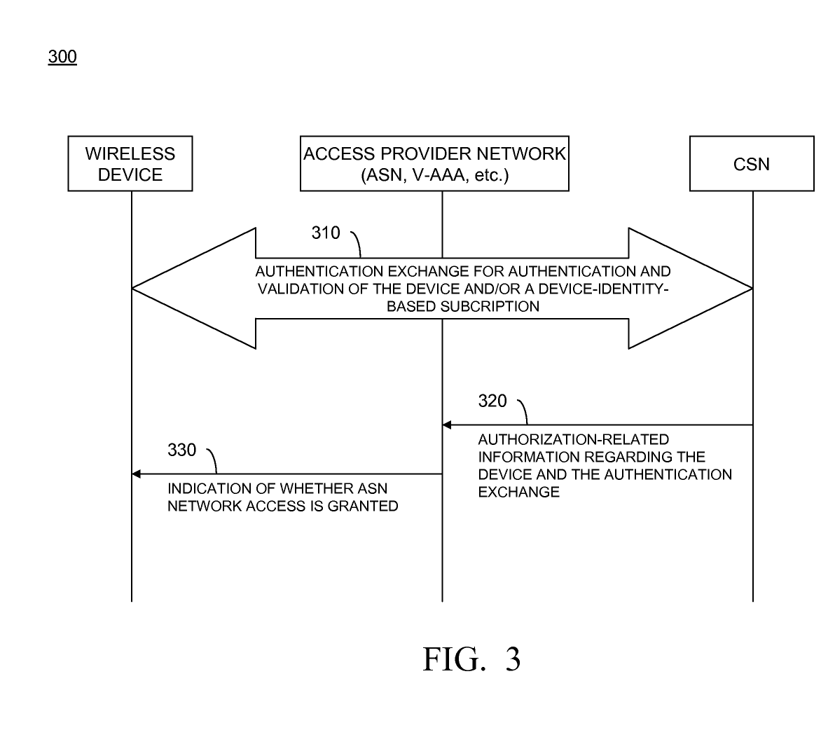

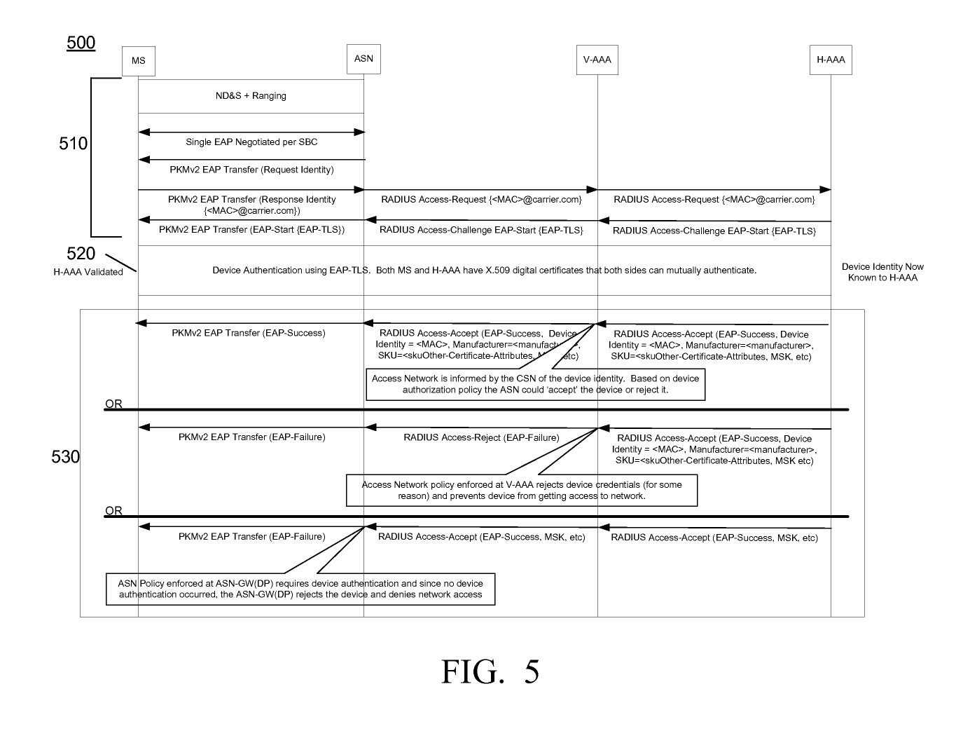

FIG. 3 is a signaling flow diagram 300 that depicts an authentication exchange by which authentication and validation of a wireless device and/or a subscription (for device-identity-based subscriptions) may occur, in accordance with multiple embodiments of the present invention. FIG. 5 is a much more detailed signaling flow diagram 500 that depicts one example of the sort of additional signaling that a WiMAX embodiment in accordance with signaling flow diagram 300 may utilize. A wireless device attempting to obtain network access via an access provider network (such as access provider network 220) performs some initial signaling to request access and perhaps begin an authentication process. An example of this sort of initial signaling is represented by signaling 510 in signaling flow diagram 500.

The wireless device and the CSN then perform an authentication exchange 310 in which a device credential from the wireless device is authenticated and validated by the CSN to establish the identity of the wireless device. There are various authentication exchange methods that may be used depending on the embodiment and/or the situation at hand. For example, the authentication exchange may be performed using an Extensible Authentication Protocol (EAP) method such as EAP-TLS (EAP—Transport Layer Security). An example of this is represented by signaling 520 and signaling flow diagram 500 in general. For the case in which the CSN also performs subscription validation, it may use a device identity obtained from the device credential to validate a device-identity-based subscription.

After performing device and/or subscription validation, the CSN indicates 320 to the access provider network authorization-related information regarding the device and the authentication exchange. The access provider network then determines whether to grant access to the wireless device based on the received indication and indicates 330 to the wireless device whether it has been granted network access or not.

Three examples of this type of signaling are represented by signaling 530 in signaling flow diagram 500. In these examples, RADIUS (a AAA protocol) returns an “Access-Accept” message after successfully completing authentication. This message indicates that the authentication server (the H-AAA here) has completed all of its validation checks and is agreeing to allow the MS access to the network. With RADIUS, Attribute Value Pairs (AVPs) may be used to pass the authorization-related information to the access provider network.

The authenticator in the access provider network (the V-AAA here), may inspect the Access-Accept data and make a determination based on local policy whether or not the device information present in the Access-Accept is sufficient to allow the device on the access provider network. It may choose not to accept the device and may reject the authentication session, preventing the device from gaining access, or it may forward the Access-Accept on to the WiMAX radio equipment (ASN) and allow the device onto its network if it has accepted the device information. Additionally or alternatively, the ASN may make a determination based on local policy whether or not the device information present in the Access-Accept is sufficient to allow the device access. Thus, either or both the V-AAA and/or ASN may be authentication policy enforcers.

Furthermore, in the RADIUS Access-Request signaling in signaling 510, the access provider network may use one or more AVPs indicate its device access policy or simply to signal to the H-AAA that device authentication is requested. For example, an AVP may indicate that if the H-AAA can not successfully authenticate the device, (i.e., device has no certificate or the certificate is invalid), the H-AAA should not accept authentication. Having this information, may allow the H-AAA to not perform device authentication if the CSN is not interested in performing device authentication and it knows that the ASN has not requested it. An AVP may also (or alternatively) indicate that if device authentication was performed, then inform the access provider network of the credentials, but if device authentication is not performed, indicate the cause (e.g., no response to certificate request, unknown certificate, etc.).

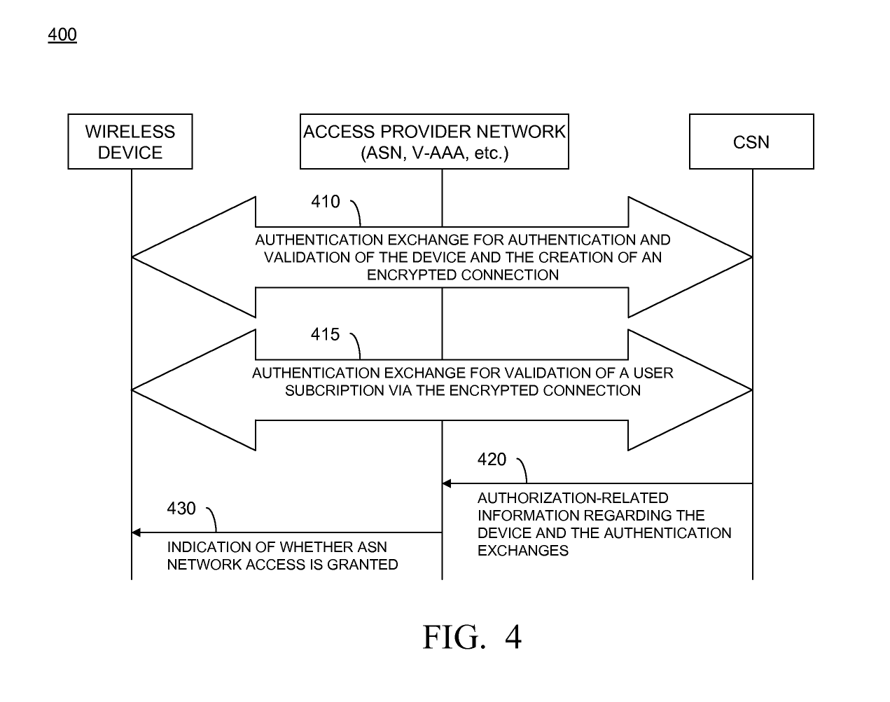

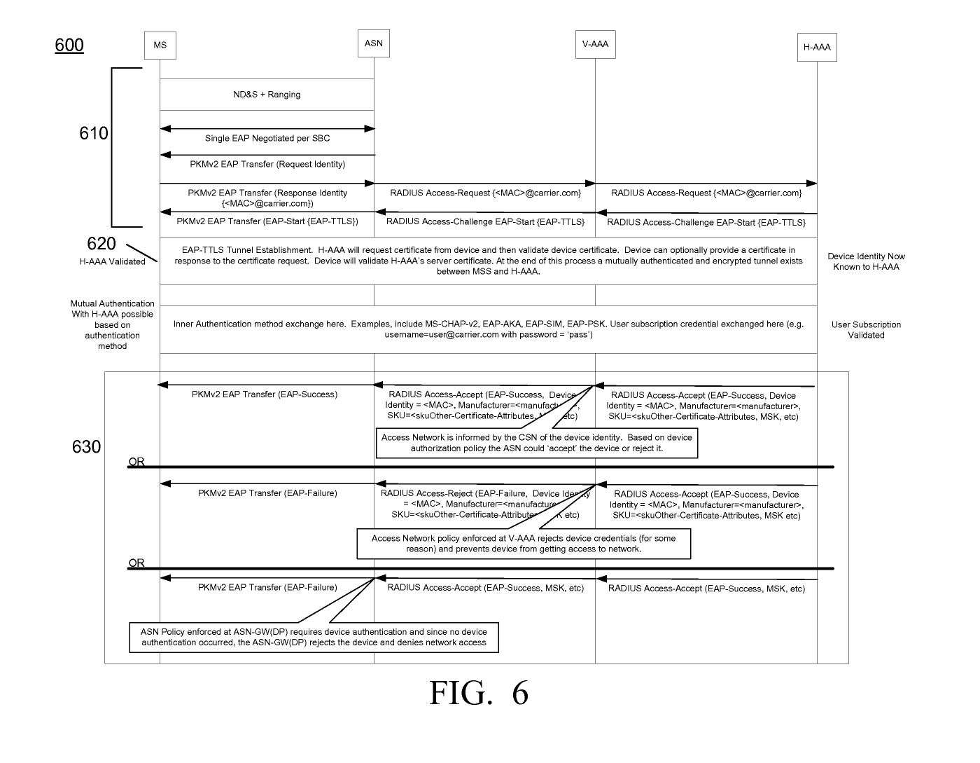

FIG. 4 is a signaling flow diagram 400 that depicts two authentication exchanges by which authentication and validation of a wireless device and a user subscription may occur, in accordance with multiple embodiments of the present invention. FIG. 6 is a much more detailed signaling flow diagram 600 that depicts one example of the sort of additional signaling that a WiMAX embodiment in accordance with signaling flow diagram 400 may utilize. A wireless device attempting to obtain network access via an access provider network (such as access provider network 220) performs some initial signaling to request access and perhaps begin an authentication process. An example of this sort of initial signaling is represented by signaling 610 in signaling flow diagram 600.

The wireless device and the CSN then performs an authentication exchange 410 in which a device credential from the wireless device is authenticated and validated by the CSN to establish the identity of the wireless device. There are various authentication exchange methods that may be used depending on the embodiment and/or the situation at hand. For example, the authentication exchange may be performed using an Extensible Authentication Protocol (EAP) method such as EAP-TTLS (EAP—Tunneled Transport Layer Security) or PEAP (Protected EAP). An example of this is represented by signaling 620 in signaling flow diagram 600. Both EAP-TTLS and PEAP utilize digital certificates to authenticate the server to the wireless device, and both offer the option of being able to request a digital certificate from the wireless device. In preferred embodiments of this invention, the optional behavior of these protocols is utilized to retrieve the device credential, thereby enabling the validation of the device by the CSN and ultimately by the ASN.

An EAP method such as EAP-TTLS or PEAP may be used as the outer EAP method, since both protocols are intended to create a secure path (i.e., an encrypted connection) through which a second (or inner) method of authentication may be performed. (Actually, once an encrypted connection is established, multiple inner authentication exchanges may be performed via the encrypted connection.) For example, once an EAP-TTLS tunnel is established with an authentication server, the MS may perform MS-CHAP-v2 (Microsoft Challenge-Handshake Authentication Protocol version 2) username/password-based authentication. The EAP-TTLS tunnel encrypts and integrity checks the exchange of user identity and the challenge messages that are used as part of MS-CHAP-v2.

In fact, once an encrypted connection is established with an authentication server, the MS may perform an authentication exchange using many different methods. Some of these include: CHAP (Challenge Authentication-Handshake Protocol), MS-CHAP (Microsoft Challenge-Handshake Authentication Protocol), MS-CHAP-v2 (see RFC 2759), PAP (Password Authentication Protocol), EAP-SIM (Extensible Authentication Protocol for Global System for Mobile Communications (GSM) Subscriber Identity Modules) (see RFC 4186), EAP-AKA (Extensible Authentication Protocol Method for 3rd Generation Authentication and Key Agreement) (see RFC 4187), and EAP-PSK (Extensible Authentication Protocol a Pre-shared Key EAP Method) (see draft-bersani-eap-psk11.txt). IETF Request for Comments (RFC) documents and draft documents may be found via http://www.ietf.org/.

Thus, using the encrypted connection between the CSN and the wireless device as a result of authentication exchange 410, authentication exchange 415 is performed. The CSN validates a user subscription using the user subscription credential obtained from the wireless device during exchange 415. After performing device and subscription validation, the CSN indicates 420 to the access provider network authorization-related information regarding the device and the authentication exchange. The access provider network then determines whether to grant access to the wireless device based on the received indication and indicates 430 to the wireless device whether it has been granted network access or not. Three examples of this type of signaling are represented by signaling 630 in signaling flow diagram 600. The above description with respect to RADIUS signaling and authentication policy enforcement with respect to diagram 500 is also generally applicable diagram 600 (e.g., signaling 610 and 630).

One of skill in the art will appreciate that various modifications and changes may be made to the specific embodiments described above without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) are intended to encompass all the various techniques available for communicating or referencing the object being indicated. Some, but not all examples of techniques available for communicating or referencing the object being indicated include the conveyance of the object being indicated, the conveyance of an identifier of the object being indicated, the conveyance of information used to generate the object being indicated, the conveyance of some part or portion of the object being indicated, the conveyance of some derivation of the object being indicated, and the conveyance of some symbol representing the object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for authenticating a wireless device by a connectivity service network (CSN) prior to granting access to an access service network (ASN), the method comprising:
performing, by the CSN via the ASN, an authentication exchange with the wireless device in which a device credential is requested;
establishing, by the CSN, an identity of the wireless device, wherein establishing the identity comprises authenticating and validating the device credential if a device credential is obtained from the wireless device;
indicating, by the CSN to an authenticator for the ASN, at least one of the established identity of the wireless device, whether the wireless device was successfully authenticated and validated, whether a Certificate Revocation List (CRL) check was performed, a hardware version of the wireless device, a manufacturer of the wireless device, information obtained from the device credential, a network interoperability certification compliance grade, an identity of a root Certificate Authority, and a session authentication key.

2. The method of claim 1, wherein the CSN comprises a Home—Authentication, Authorization and Accounting Server (H-AAA) and wherein the authenticator for the ASN comprises a Visited—Authentication, Authorization and Accounting Proxy Server (V-AAA).

3. The method of claim 1, wherein performing the authentication exchange comprises
performing the authentication exchange using an Extensible Authentication Protocol (EAP) method.

4. The method of claim 3, wherein the EAP method used is EAP-TLS (EAP—Transport Layer Security).

5. The method of claim 1, further comprising:
establishing an encrypted connection between the CSN and the wireless device as a result of the authentication exchange;
utilizing a device identity obtained from the device credential to validate a device-identity-based subscription,
wherein indicating to the authenticator for the ASN comprises indicating in response to successfully validating the device-identity-based subscription.

6. The method of claim 1, further comprising:
establishing an encrypted connection between the CSN and the wireless device as a result of the authentication exchange;
performing, by the CSN via the encrypted connection, a second authentication exchange with the wireless device in which a user subscription credential is requested;
validating a user subscription using the user subscription credential obtained,
wherein indicating to the authenticator for the ASN comprises indicating in response to successfully validating the user subscription.

7. The method of claim 6, wherein performing the authentication exchange comprises
performing the authentication exchange using an Extensible Authentication Protocol (EAP) method,
wherein the EAP method used is one of EAP-TTLS (EAP—Tunneled Transport Layer Security) and PEAP (Protected EAP).

8. The method of claim 6, wherein performing, by the CSN via the encrypted connection, the second authentication exchange comprises performing the second authentication exchange using at least one of CHAP (Challenge Authentication-Handshake Protocol), MS-CHAP (Microsoft Challenge-Handshake Authentication Protocol), MS-CHAP-v2 (Microsoft Challenge-Handshake Authentication Protocol version 2), PAP (Password Authentication Protocol), EAP-SIM (Extensible Authentication Protocol for Global System for Mobile Communications (GSM) Subscriber Identity Modules), EAP-AKA (Extensible Authentication Protocol Method for 3rd Generation Authentication and Key Agreement), and EAP-PSK (Extensible Authentication Protocol a Pre-shared Key EAP Method).

9. The method of claim 6, wherein the user subscription credential comprises at least one of a user name and password combination, biometric information, subscriber identity information, and preshared key.

10. A method for authenticating a wireless device by a connectivity service network (CSN) prior to granting access to an access service network (ASN), the method comprising:
performing, by the wireless device via the ASN, a first authentication exchange with the CSN in which a device credential is provided by the wireless device, the first authentication exchange producing an encrypted connection between the CSN and the wireless device;
performing, by the wireless device via the encrypted connection, a second authentication exchange with the CSN in which a user subscription credential is provided by the wireless device;
receiving, by the wireless device as a result of the first and second authentication exchanges, an indication of whether the wireless device has been granted access on the ASN.

11. The method of claim 10, wherein performing the first authentication exchange comprises
performing the first authentication exchange with the CSN in which a server credential is requested by the wireless device.

12. The method of claim 10, wherein performing the first authentication exchange comprises
performing the authentication exchange using an Extensible Authentication Protocol (EAP) method,
wherein the EAP method used is one of EAP-TTLS (EAP—Tunneled Transport Layer Security) and PEAP (Protected EAP).

13. The method of claim 10, wherein performing the second authentication exchange comprises
performing the second authentication exchange using at least one of CHAP (Challenge Authentication-Handshake Protocol), MS-CHAP (Microsoft Challenge-Handshake Authentication Protocol), MS-CHAP-v2 (Microsoft Challenge-Handshake Authentication Protocol version 2), PAP (Password Authentication Protocol), EAP-SIM (Extensible Authentication Protocol for Global System for Mobile Communications (GSM) Subscriber Identity Modules), EAP-AKA (Extensible Authentication Protocol Method for 3rd Generation Authentication and Key Agreement), and EAP-PSK (Extensible Authentication Protocol a Pre-shared Key EAP Method).

14. The method of claim 10, wherein the user subscription credential comprises at least one of a user name and password combination, biometric information, subscriber identity information, and preshared key.

15. A method for authenticating a wireless device by a connectivity service network (CSN) prior to granting access to an access service network (ASN), the method comprising:
requesting, by an access provider network, the CSN to authenticate the wireless device, wherein the access provider network comprises the ASN;
receiving, by the access provider network from the CSN, an indication of at least one of the established identity of the wireless device, whether the wireless device was successfully authenticated, whether a Certificate Revocation List (CRL) check was performed, a hardware version of the wireless device, a manufacturer of the wireless device, information obtained from the device credential, a network interoperability certification compliance grade, an identity of a root Certificate Authority, and a session authentication key;
determining, by the access provider network, whether to grant access to the wireless device based on the received indication;
indicating, to the wireless device by the ASN, whether the wireless device has been granted access.

16. The method of claim 15, wherein requesting the CSN to authenticate the wireless device comprises indicating at least one of whether device authentication is requested and a device access policy of the access provider network.

17. The method of claim 15, wherein the access provider network comprises the ASN and a visited network authenticator and
wherein determining whether to grant access to the wireless device based on the received indication comprises determining, by at least one of the ASN and the visited network authenticator, whether to grant access to the wireless device using a device access policy.

18. The method of claim 17, wherein the CSN comprises a Home—Authentication, Authorization and Accounting Server (H-AAA) and wherein the visited network authenticator comprises a Visited—Authentication, Authorization and Accounting Proxy Server (V-AAA).

19. A wireless device comprising:
a transceiver;
a processing unit, communicatively coupled to the transceiver,
adapted to perform, via the transceiver and an access service network (ASN), a first authentication exchange with a connectivity service network (CSN) in which a device credential is provided by the wireless device, the first authentication exchange producing an encrypted connection between the CSN and the wireless device,
adapted to perform, via the transceiver and the encrypted connection, a second authentication exchange with the CSN in which a user subscription credential is provided by the wireless device, and
adapted to receive, via the transceiver and as a result of the first and second authentication exchanges, an indication of whether the wireless device has been granted access on the ASN.
